(19) United States
(12) Patent Application Publication
(10) Pub. No.: US 2020/0028394 A1
(43) Pub. Date: Jan. 23, 2020

(54) ROTOR UNIT

(71) Applicant: HONDA MOTOR CO., LTD., Tokyo (JP)

(72) Inventor: Nyatto TATSUNAGA, Wako-shi (JP)

(21) Appl. No.: 16/510,283

(22) Filed: Jul. 12, 2019

(30) Foreign Application Priority Data
Jul. 17, 2018 (JP) 2018-133905

(51) Int. Cl. H02K 1/30; H02K 1/27

(52) U.S. Cl. CPC H02K 1/30; H02K 1/278; H02K 1/276

(57) ABSTRACT

A rotor unit includes a rotor core, a magnet provided in the rotor core and extending in an axial direction, a rotating shaft inserted through a center of the rotor core, and an endplate provided on an end face in the axial direction of the rotor core. The end plate includes an end face pressing part arranged on an outer peripheral side of the rotor core and facing the magnet, and a press-fit holding part arranged on an inner peripheral side of the rotor core and press-fitted to the rotating shaft, and the end face pressing part and the press-fit holding part are combined together by casting.

### CROSS-REFERENCE TO RELATED APPLICATION

This application is based upon and claims priority from the Japanese Patent Application No. 2018-133905, filed on Jul. 17, 2018, the entire contents of which are incorporated herein by reference.

### BACKGROUND OF THE INVENTION

### 1. Field of the Invention

The present invention relates to a rotor unit.

### 2. Description of the Related Art

As conventional art, a rotor (rotor unit) has been proposed which includes a shaft rotatably supported, a rotor core (yoke) attached to the shaft, a magnet provided in the rotor core, and end face plates that hold the magnet. For example, in the case of a rotor (rotor unit) disclosed in Japanese Patent No. 4837288 (Patent document 1), a rotor core is first attached to a shaft and end face plates are then fixed to the shaft by press-fitting collars to the shaft from one side in an axial direction.

However, the rotor unit disclosed in Patent document 1 requires press-fitting the collars to the shaft one by one, thus posing problems in that the number of parts are increased to require man-hours for assembling.

The present invention has therefore been made to solve the above problems, and an object of the invention is to provide a rotor unit that makes it possible to reduce man-hours for assembling.

### SUMMARY OF THE INVENTION

In order to attain the above object, according to an aspect of the present invention, a rotor unit reflecting one aspect of the present invention includes: a rotor core; a magnet provided in the rotor core and extending in an axial direction; a rotating shaft inserted through a center of the rotor core; and an endplate provided on an end face in the axial direction of the rotor core, wherein the end plate includes an end face pressing part arranged on an outer peripheral side of the rotor core and facing the magnet, and a press-fit holding part arranged on an inner peripheral side of the rotor core and press-fitted to the rotating shaft, and the end face pressing part and the press-fit holding part are combined together by casting.

The present invention allows a rotor unit to be provided, which makes it possible to reduce man-hours for assembling.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1 is a cross-sectional view showing a rotor unit according to a first embodiment of the present invention.

FIGS. 2A to 2C are diagrams showing an end plate used in the rotor unit according to the first embodiment, in which FIG. 2A is a front view of the end plate; FIG. 2B is a front view showing a press-fit holding part of the end plate; and FIG. 2C is a cross-sectional view showing a direction in which the press-fit holding part is formed.

FIGS. 3A to 3D are process diagrams showing a method of manufacturing the end plate.

FIG. 4 is a cross-sectional view showing a rotor unit according to a second embodiment of the present invention.

FIG. 5 is a front view showing a press-fit holding part of an end plate in the second embodiment.

FIG. 6 is a cross-sectional view showing a rotor unit according to a third embodiment of the present invention.

FIG. 7 is a cross-sectional view showing a rotor unit according to a fourth embodiment of the present invention.

FIG. 8 is a cross-sectional view showing a rotor unit according to a fifth embodiment of the present invention.

### DETAILED DESCRIPTION OF THE PREFERRED EMBODIMENTS

Embodiments of the present invention will be hereinafter described in detail with reference to the accompanying drawings as appropriate. Note that in the drawings, the same component is given the same reference sign. Moreover, sizes and shapes of members are schematically illustrated with modification or exaggeration in some cases, for the sake of explanatory convenience. Furthermore, a direction in an output axis of the motor is simply referred to as an “axial direction”, a direction which goes around the axial direction is simply referred to as a “circumferential direction”, and a direction orthogonal to the axial direction is simply referred to as a “radial direction”.

### First Embodiment

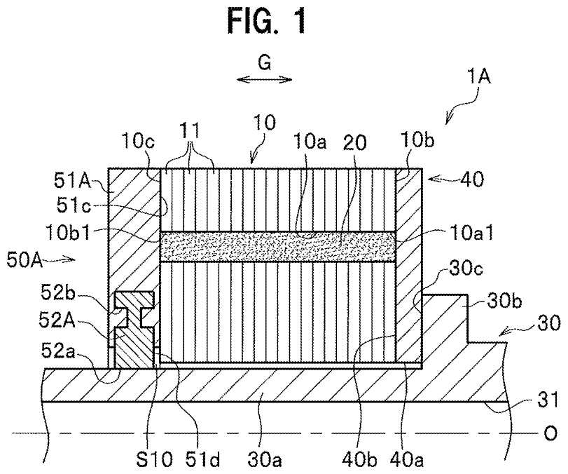

FIG. 1 is a cross-sectional view showing a rotor unit according to a first direction. It should be noted that the rotor unit will be described by citing how the rotor unit is applied to an interior permanent magnet motor (IPM motor).

As illustrated in FIG. 1, the rotor unit 1A according to the first embodiment includes: a rotor core 10; magnets 20 provided in the rotor core 10, and extending in the axial direction G; a rotating shaft 30 inserted through a center (axial center, rotation center) O of the rotor core 10; and end plates (end face plates) 40, 50A provided on the end faces of the rotor core 10 in the axial direction G. It should be noted that the end plate 50A corresponds to an end plate recited in the scope of claims.

The rotor core 10 (also referred to as a “rotor yoke”) is formed from multiple magnetic plate members (electromagnetic steel plates) 11 stacked together in the axial direction G. In addition, multiple housing holes 10a in which to house the magnets 20 are formed in parallel in the outer peripheral side of the rotor core 10 in a way that makes the housing holes 10a penetrate through the rotor core 10 in the axial direction G. Incidentally, the housing holes 10a are formed at equal intervals in the circumferential direction.

The magnets 20 are each formed of a permanent magnet made of a rare-earth element such as neodymium. Furthermore, in a plan view in the axial direction G, the magnets 20 are each formed in an arc shape or a rectangular shape. Moreover, the magnets 20 are retained within their respective housing holes 10a in a way that makes the magnets 20 movable (slidable) in the axial direction G, but not fixed to the insides of the housing holes 10a with resin of the like. The magnets 20 are formed as long in the axial direction G as the housing holes 10a are, and such that two end faces of each magnet 20 in the axial direction G are flush with two end faces 10b, 10c of the rotor core 10 in the axial direction G. Incidentally, although the first embodiment has been discussed by citing an example in which a single magnet 20 extends in the axial direction G, multiple divided magnets 20 may be arranged in the axial direction G.

The rotating shaft 30 is a hollow cylindrical member made of stainless steel, iron or the like, and is formed by forging, casting, machining or the like. In addition, the interior of the rotating shaft 30 is a hollow extending in the axial direction G, and serves as a coolant passage 31 through which coolant supplied from an oil pump (not illustrated) flows.

Moreover, the rotating shaft 30 includes a shaft part 30a inserted through the rotor core 10. A diameter-enlarged part 30b formed larger than the diameter (outer diameter) of the shaft part 30a is formed on one side of the shaft part 30a in the axial direction G. The diameter-enlarged part 30b includes a face 30c which faces the rotor core 10 in the axial direction G, and which is orthogonal to the axial direction G.

The end plate 40 (also referred to as the “end face plate”) is formed in a disk shape, and is made of a nonmagnetic metal material, for example SUS304, aluminum, copper or the like, as well as is arranged coaxially with the rotating shaft 30. In addition, the endplate 40 includes a through hole 40a formed in its center portion in the radial direction, and penetrating through the end plate 40 in the axial direction G. The inner diameter of the through hole 40a is formed equal to (or slightly larger than) the outer diameter of the shaft part 30a of the rotating shaft 30. Furthermore, the end plate 40 contacts the face 30c of the diameter-enlarged part 30b of the rotating shaft 30, and this contact restricts the movement of the end plate 40 in the axial direction G.

Moreover, the outer diameter of the end plate 40 is formed equal to the outer diameter of the rotor core 10. Besides, the end plate 40 is arranged facing one end face 10b of the rotor core 10, and covers openings 10a1 of the respective housing holes 10a in the axial direction G. In addition, a surface 40b of the end plate 40 which faces the rotor core 10 contacts the end face 10b of the rotor core 10 and end portions of the magnets 20. The providing of the end plate 40 like this prevents the magnets 20 from coming out of the openings 10a1 of the housing holes 10a.

The endplate 50A is provided on an opposite side of the rotor core 10 from the endplate 40 in the axial direction G. In addition, the end plate 50A includes: an end face pressing part 51A formed in a substantially disk-like shape, and arranged on its outer peripheral side in the radial direction; and a press-fit holding part 52A arranged on its inner peripheral side in the radial direction.

A stator core (not illustrated) is arranged surrounding the rotor unit 1A. A stator coil (not illustrated) is installed in the stator core. In addition, the stator core is formed from, for example, annular thin electromagnetic steel plates stacked together in the axial direction G. The stator core includes multiple slots (grooves) formed in its inner circumferential surface at equal intervals in the circumferential direction. The stator coil is formed from multiple coil segments (for example, a U-phase coil segment, a V-phase coil segment and a W-phase segment) attached to the slots.

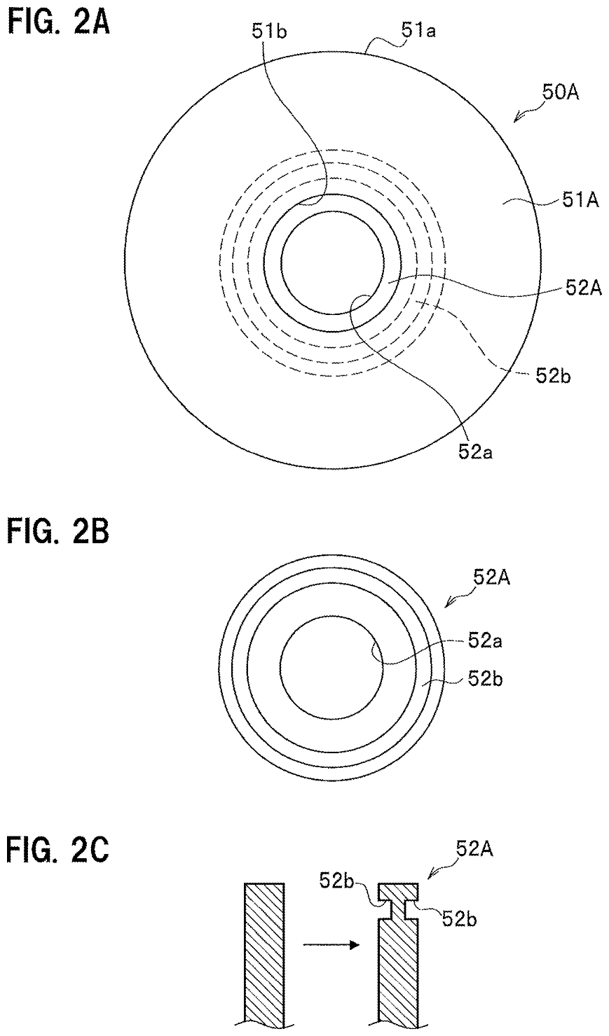

FIG. 2A is a front view showing the end plate used in the rotor unit according to the first embodiment. FIG. 2B is a front view showing the press-fit holding part of the end plate. FIG. 2C is a cross-sectional view showing a direction in which the press-fit holding part of the end plate is formed.

As illustrated in FIG. 2A, the end face pressing part 51A is formed in an annular plate shape, and its outer peripheral edge 51a has a diameter which is as large as that of the rotor core 10 (see FIG. 1). In addition, the end face pressing part 51A is made of a nonmagnetic metal material, for example aluminum Al (a metal containing aluminum). Incidentally, the material of the end face pressing part 51A is not limited to aluminum, and may be a different metal like an aluminum alloy.

The press-fit holding part 52A is formed in an annular plate shape, and coaxially with the end face pressing part 51A. In addition, the press-fit holding part 52A is partially exposed to the outside from an inner peripheral edge 51b of the end face pressing part 51A. Furthermore, the press-fit holding part 52A is made of a material having a linear expansion coefficient equal to that of the material of the rotating shaft 30 (see FIG. 1), for example iron Fe (a metal containing iron). Incidentally, the material of the press-fit holding part 52A is not limited to iron, and may be a different metal like a stainless steel (SUS) (this is the case with the other embodiments).

As illustrated in FIG. 2B, a circular shaft hole 52a into which to insert the shaft part 30a of the rotating shaft 30 (see FIG. 1) is formed in the center of the press-fit holding part 52A in the radial direction. The press-fit holding part 52A further includes grooves 52b each formed annularly in its outer peripheral side and extending in the circumferential direction. Each groove 52b is formed extending fully in a circle in the circumferential direction, and coaxially with the shaft hole 52a. Furthermore, a direction in which the groove 52b is opened is set at the axial direction G. Incidentally, the groove 52b is not limited to that formed extending fully in a circle in the circumferential direction, and may be that whose parts are formed intermittently to form parts of a whole circle in the circumferential direction.

As illustrated in FIG. 2C, the press-fit holding part 52A includes grooves 52b, 52b formed by pressing a plate member with two flat surfaces from two sides in a surface direction (in the axial direction). In addition, the grooves 52b are formed at their respective positions which are away from the center in the radial direction by the same radius. Furthermore, the grooves 52b have the same recessed cross-sectional shape. Incidentally, the grooves 52b may be formed respectively in positions which are mutually different from each other in the radial direction. Besides, the grooves 52b do not have to have the same cross-sectional shape, and may have mutually-different cross-sectional shapes. Moreover, the number of grooves 52b to be formed in each face of the press-fit holding part 52A is not necessarily limited to one, and multiple grooves 52b may be formed in each surface thereof.

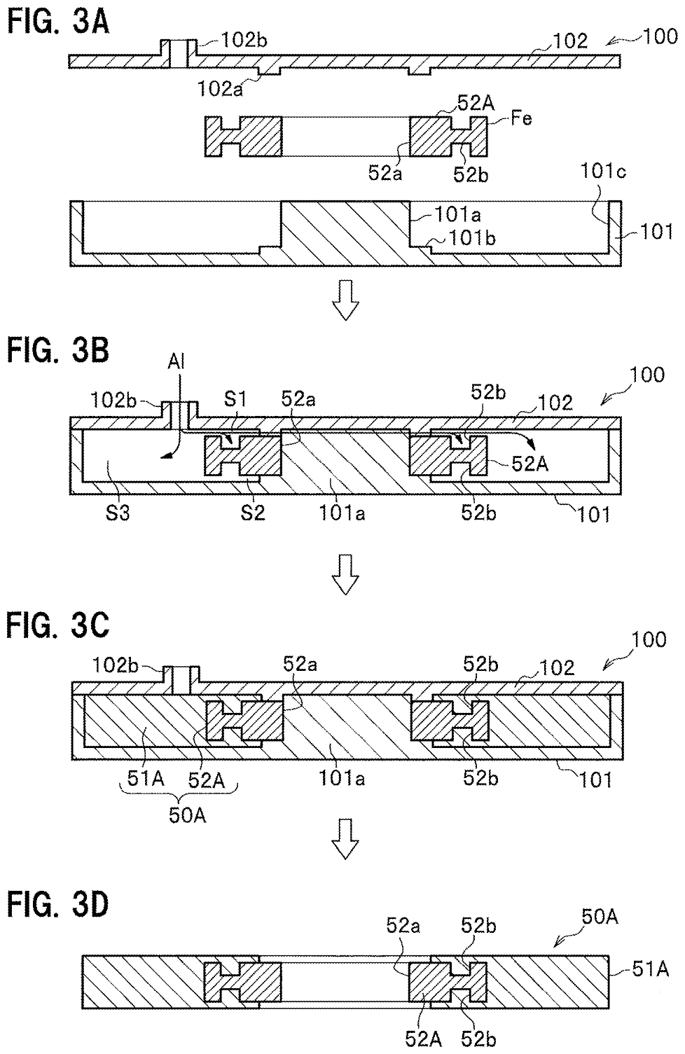

FIGS. 3A to 3D are process diagrams showing a method of manufacturing the end plate.

FIG. 3A illustrates how the press-fit holding part 52A is positioned relative to, and fixed to, a mold 100. Before positioned relative to the mold 100, the press-fit holding part 52A is formed with the method which has been described using FIG. 2C. The mold 100 includes: a main body part 101 formed in a substantially recessed shape; and a lid part 102 for covering an upper opening in the main body part 101. In addition, a projecting part 101a to be fitted into the shaft hole 52a of the press-fit holding part 52A is formed in the center of the main body part 101 in the radial direction. Furthermore, in the main body part 101, a projection-shaped step part 101b is annularly formed surrounding the lower end of the projecting part 101a. Moreover, on the lower surface of the lid part 102, an annular ridge part 102a is formed at a position corresponding to the step part 101b. The press-fit holding part 52A is positioned relative to the main body part 101 of the thus-configured mold 100, and the lid part 102 closes the upper opening 101c of the main body part 101.

FIG. 3B illustrates how aluminum is cast into the mold 100. Specifically, when the press-fit holding part 52A is positioned relative to the mold 100, spaces S1, S2, S3 are formed. The space S1 is formed between the groove 52b of the press-fit holding part 52A and the lid part 102. The space S2 is formed between the groove 52b and the bottom surface of the main body part 101. The space S3 is formed outside the outer periphery of the press-fit holding part 52A. Thereafter, molten aluminum is poured via an inlet port 102b of the lid part 102.

FIG. 3C illustrates the mold 100 which has been filled with aluminum. Specifically, when the mold 100 is filled with aluminum, the empty area excluding the press-fit holding part 52A (that is, the spaces S1, S2, S3) in the mold 100 is filled with aluminum. Incidentally, the press-fit holding part 52A is made of iron, and its melting point is higher than that of aluminum. For this reason, the mold 100 can be filled with aluminum while the press-fit holding part 52A keeps its shape.

FIG. 3D illustrates the end plate 50A which is detached from the mold 100. Specifically, aluminum of the end face pressing part 51A is fitted into the recessed grooves 52b, 52b of the press-fit holding part 52A.

When the thus-configured end plate 50A is press-fitted to the rotating shaft 30 (see FIG. 1), a surface 51c (see FIG. 1) of the end face pressing part 51A which faces the rotor core 10 comes into contact with the end face 10c of the rotor core 10 (see FIG. 1). In addition, a surface 51d of the press-fit holding part 52A which faces the rotor core 10 is formed in a shape which is set back from the end face 10c of the rotor core 10, that is to say, the space S10 is formed between the surface 51d and the end face 10c.

Meanwhile the linear expansion coefficient of iron is approximately 11 (10⁻⁶/° C.), while the linear expansion coefficient of aluminum is approximately 23 (10⁻⁶/° C.). Since the linear expansion coefficient of aluminum is thus greater than that of iron, aluminum expands to grow into iron when the temperature is high (during the operation). This offers a mechanism which does not allow iron and aluminum to come off each other.

Although not illustrated, as an example comparative to the first embodiment, an end plate can be formed by combining resin used as the material of an end face pressing part and aluminum used as the material of a press-fit holding part. Since the end face portion is made of the resin, however, the thus-combined end plate involves likelihood that in a case where the design not to fix the magnets with the resin or the like is employed, the magnets are freely movable in the axial direction to collide against, wear out and break the resin part while the rotor is rotating. For this reason, the magnets need to be fixed in the rotor core with the resin. The fixing with the resin, however, costs a lot. In addition, since the magnets need to be inserted into the rotor core before the rotor core is press-fitted, man-hours for assembling is greater than otherwise.

With this taken into consideration, the first embodiment builds the end plate 50A by integrating the iron-made press-fit holding part on the inner peripheral side and the aluminum-made part on the outer peripheral part for preventing the magnets from coming off.

As discussed above, the rotor unit 1A according to the first embodiment includes: the rotor core 10; the magnets 20 provided in the rotor core 10, and extending in the axial direction G; the rotating shaft 30 inserted through the center O of the rotor core 10; and the endplate 50A provided on the end face of the rotor core 10 in the axial direction G. The end plate 50A includes: the end face pressing part 51A arranged on the outer peripheral side of the rotor core 10, and facing the magnets 20; and the press-fit holding part 52A arranged on the inner peripheral side of the rotor core 10, and press-fitted to the rotating shaft 30. The end face pressing part 51A and the press-fit holding part 52A are combined together by casting. This configuration makes it possible to make the end face pressing part 51A of a metal by casting the end face pressing part 51A to the press-fit holding part 52A (by casting). It is therefore possible to prevent the magnets 20 from coming (dropping) out of the openings 10b1 of the rotor core 10 while making the metal part of the press-fit holding part 52A exert the collar characteristic (the press-fitted function).

In addition, in the first embodiment, in the end plate 50A, the end face pressing part 51A and the press-fit holding part 52A are combined together with the end face pressing part 51A fitted to the press-fit holding part 52A. This configuration makes the grooves 52b, 52b have the shape which allows the metal of the end face pressing part 51A to be fitted into (fitted to) the grooves 52b, 52b, and makes the end face pressing part 51A less likely to come off the press-fit holding part 52A.

Furthermore, in the first embodiment, the end face pressing part 51A is made of aluminum, and the press-fit holding part 52A is made of iron. Since the linear expansion coefficient of aluminum is greater than that of iron, the aluminum-made end face pressing part 51A expands to grow into the grooves 52b, 52b of the iron-made press-fit holding part 52A when the temperature of the rotor core 10 becomes high. This offers the structure which makes the press-fit holding part 52A much less likely to come off the end face pressing part 51A.

Moreover, in the first embodiment, the magnets 20 are inserted in the respective housing holes 10a in the rotor core 10, and are formed movable in the axial direction G. The makes it unnecessary to fix the magnets 20 in the housing holes 10a with resin, and makes it possible to reduce costs which the resin fixing would otherwise entail. Furthermore, since the resin fixing is no longer needed, man-hours for assembling can be reduced.

Besides, in the first embodiment, the surface 51d of the press-fit holding part 52A which faces the rotor core 10 is set back from the face 51c of the end face pressing part 51A which faces the rotor core 10 (thereby, the space S10 is formed there). This makes it possible to press the end face pressing part 51A against the end face 10c of the rotor core 10 without being interfered by the end face of the press-fit holding part 52A when the end plate 50A is press-fitted, and accordingly to securely press the magnets 20 in the rotor core 10.

What is more, in the first embodiment, the direction in which each groove 52b is opened coincides with the axial direction G. This makes the end face pressing part 51A less likely to come off the press-fit holding part 52A than in a case where the direction in which the groove is opened coincides with the direction orthogonal to the axial direction.

### Second Embodiment

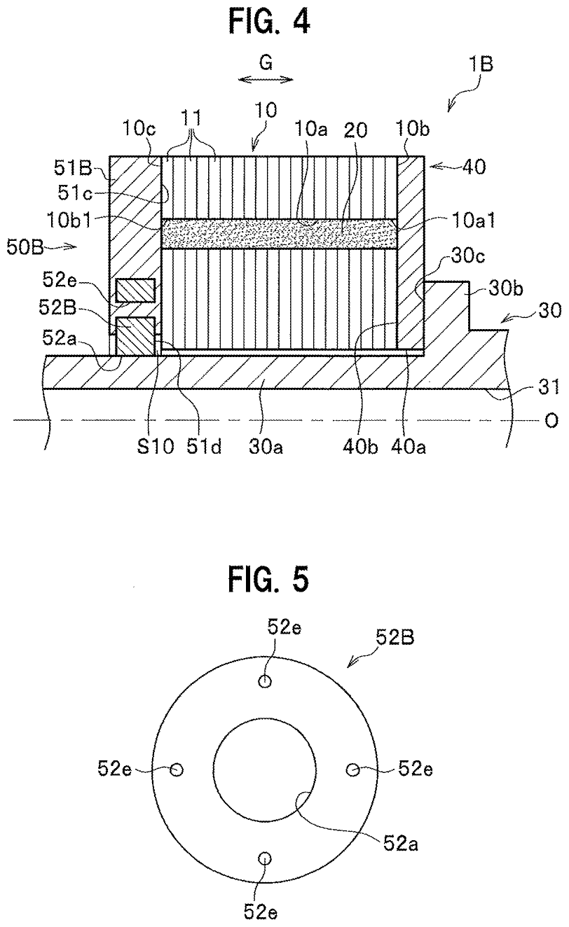

FIG. 4 is a cross-sectional view showing a rotor unit according to a second embodiment.

As illustrated in FIG. 4, the rotor unit 1B according to the second embodiment includes an end plate 50B instead of the end plate 50A according to the first embodiment.

The end plate 50B includes: an end face pressing part 51B formed in a substantially disk-like shape, and arranged on its outer peripheral side in the radial direction; and a press-fit holding part 52B arranged on its inner peripheral side in the radial direction. In addition, the end plate 50B is a combination of the end face pressing part 51B and the press-fit holding part 52B which is obtained by casing aluminum serving as the end face pressing part 51B to the iron-made press-fit holding part 52B.

FIG. 5 is a front view showing the press-fit holding part of the end plate according to the second embodiment.

As illustrated in FIG. 5, the circular shaft hole 52a into which to insert the shaft part 30a of the rotating shaft 30 (see FIG. 1) is formed in the center of the press-fit holding part 52B in the radial direction. In addition, the press-fit holding part 52B includes multiple holes 52e formed extending in the circumferential direction. Furthermore, the holes 52e are formed at four locations arranged at intervals of 90 degrees in the circumferential direction. The holes 52e are formed at the four locations which are equidistant from the rotation center. Nevertheless, the number of holes 52e is not limited to four, and may be five or more, or less than three. Moreover, the shape of each hole 52e is not limited to a circular one, and may be a different one, such as an elongated one.

Furthermore, the holes 52e are formed penetrating through the flat plate member from one surface to the other surface of the member in the axial direction G (see FIG. 4). Incidentally, the holes 52e are each formed in the shape of a straight line extending in the axial direction G (see FIG. 4). Nevertheless, the shape of the holes 52e is not limited to the straight line, and the holes 52e may be formed curved in their middles, or inclined to the axial direction G. Furthermore, each hole 52e is formed having a diameter which is unchanged from one end to the other end. Nevertheless, the diameter may be changed.

The thus-configured rotor unit 1B according to the second embodiment includes the end plate 50B instead of the end plate 50A according to the first embodiment. This configuration makes it possible to make the end face pressing part 51B of a metal by casting the end face pressing part 51B to the press-fit holding part 52B (by casting), like in the first embodiment. It is therefore possible to prevent the magnets 20 from coming (dropping) out of the openings 10b1 of the rotor core 10 while making the metal part of the press-fit holding part 52B exert the collar characteristic (the press-fitted function).

In addition, in the second embodiment, the end face pressing part 51B and the press-fit holding part 52B are combined together by fitting (with) the end face pressing part 51B (fitted) to the press-fit holding part 52B. This configuration allows the end face pressing part 51B to be fitted into (fitted to) the holes 52e formed in the press-fit holding part 52B, and makes the end face pressing part 51B less likely to come off the press-fit holding part 52B.

Furthermore, in the second embodiment, the end face pressing part 51B is made of aluminum, and the press-fit holding part 52B is made of iron. Since the linear expansion coefficient of aluminum is greater than that of iron, the aluminum-made end face pressing part 51B expands to grow into the holes 52e of the iron-made press-fit holding part 52B when the temperature of the rotor core 10 becomes high. This offers the structure which makes the press-fit holding part 52B much less likely to come off the end face pressing part 51B.

Moreover, in the second embodiment, the magnets 20 are inserted in the respective housing holes 10a in the rotor core 10, and are formed movable in the axial direction G. This makes it unnecessary to fix the magnets 20 in the housing holes 10a with resin, and makes it possible to reduce costs which the resin fixing would otherwise entail. Furthermore, since the resin fixing is no longer needed, man-hours for assembling can be reduced.

Besides, in the second embodiment, the surface 51d of the press-fit holding part 52B which faces the rotor core 10 has a shape in which the surface 51d is set back (away) from the end face 10c of the end face pressing part 51B. This makes it possible to bring the end face pressing part 51B into surface contact with the end face 10c of the rotor core 10, and accordingly to securely inhibit the movement of the magnets 20 inserted in the rotor core 10.

### Third Embodiment

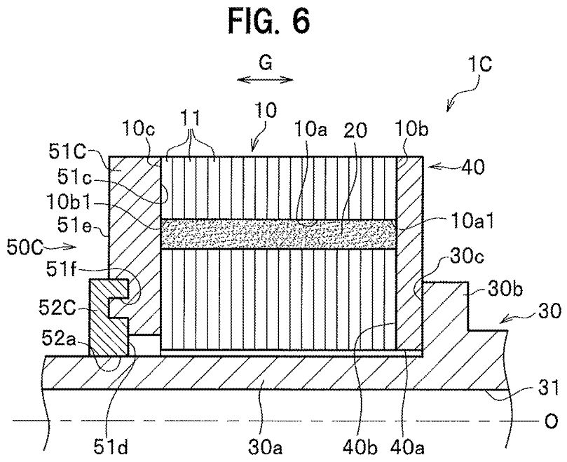

FIG. 6 is a cross-sectional view showing a rotor unit according to a third embodiment.

As illustrated in FIG. 6, the rotor unit 1D according to the third embodiment includes an end plate 50C instead of the end plate 50A according to the first embodiment.

The end plate 50C includes: an end face pressing part 51C formed in a substantially disk-like shape, and arranged on its outer peripheral side in the radial direction; and a press-fit holding part 52C arranged on its inner peripheral side in the radial direction. A groove 51f is formed in one face of the press-fit holding part 52C by pressing a flat plate member.

In addition, in the end plate 50C, the end face pressing part 51C and the press-fit holding part 52C are combined together by casting aluminum serving as the end face pressing part 51C to the press-fit holding part 52C (by casting). The press-fit holding part 52C is formed in an annular plate shape, and fitted to a surface 51e of the end face pressing part 51C which is opposite from the rotor core 10.

The thus-configured rotor unit 1C according to the third embodiment includes the end plate 50C instead of the end plate 50A according to the first embodiment. This configuration makes it possible to make the end face pressing part 51C of a metal by casting aluminum serving as the end face pressing part 51C to the iron-made press-fit holding part 52C (by casting), like in the first embodiment. It is therefore possible to prevent the magnets 20 from coming (dropping) off the rotor core 10 while making the metal part of the press-fit holding part 52C exert the collar characteristic (the press-fitted function).

Furthermore, in the third embodiment, the press-fit holding part 52C is arranged on the side opposite of the end face pressing part 51C from the rotor core 10 in the axial direction G. This makes the end face pressing part 51C less likely to come off the press-fit holding part 52C.

### Fourth Embodiment

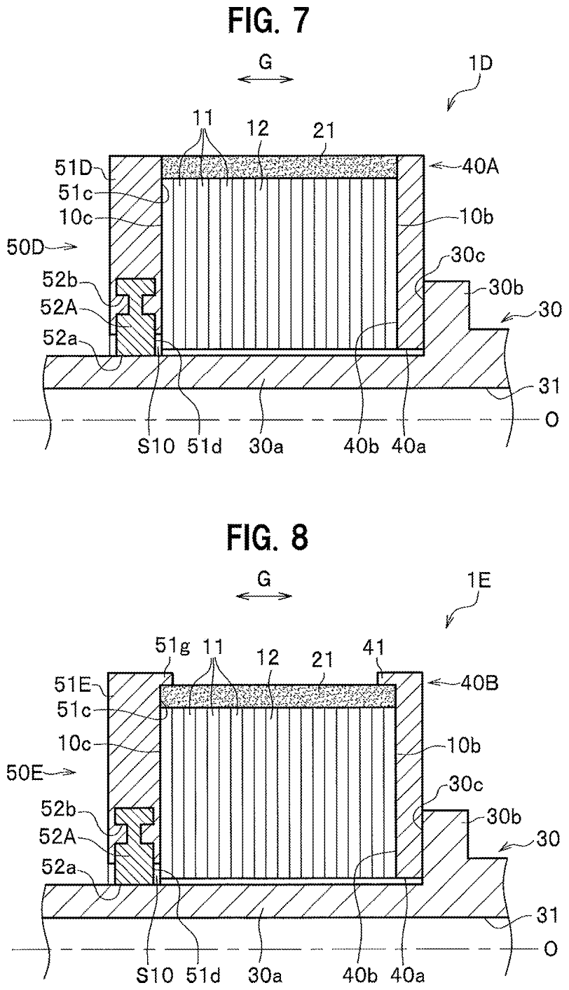

FIG. 7 is a cross-sectional view showing a rotor unit according to a fourth embodiment. It should be noted that the following descriptions will be provided for the rotor unit which is applied to a surface permanent magnet motor (SPM motor) instead of the IPM motor.

As illustrated in FIG. 7, the rotor unit 1D according to the fourth embodiment includes: a rotor core 12; magnets 21 provided in the rotor core 12, and extending in the axial direction G; the rotating shaft 30 inserted through the center (rotation center) 0 of the rotor core 12; and end plates 40A, 50D provided on the end faces of the rotor core 12 in the axial direction G. It should be noted that the end plate 50D corresponds to the end plate recited in the scope of claims.

The rotor core 12 (also referred to as a “rotor yoke”) is formed from the multiple magnetic plate members (electromagnetic steel plates) 11 stacked together in the axial direction G. In addition, the magnets 21 are retained on the outer peripheral surface of the rotor core 12.

The magnets 21 are each formed of a permanent magnet made of a rare-earth element such as neodymium. Furthermore, in a plan view in the axial direction G, the magnets 21 are formed in an arc shape or a rectangular shape, and elongated as long as the length of the rotor core 12 from one end 10b to the other end 10c of the rotor core 12. In addition, the magnets 21 are fixed to the outer peripheral surface of the rotor core 12 with an adhesive, and are arranged at equal intervals in the circumferential direction.

The end plate 40A is formed in a disk shape, and is made of a nonmagnetic metal material, for example SUS304, aluminum, copper or the like, as well as is arranged coaxially with the rotating shaft 30. In addition, the outer diameter of the end plate 40A is formed equal to those of the magnets 21. Furthermore, the surface 40b of the end plate 40A which faces the rotor core 12 contacts the end face 10b of the rotor core 12 and end portions of the magnets 21.

The end plate 50D is provided on an opposite side of the rotor core 12 from the end plate 40A in the axial direction G. In addition, the end plate 50D includes: an end face pressing part 51D formed in a substantially disk-like shape, and arranged on its outer peripheral side in the radial direction; and the press-fit holding part 52A arranged on its inner peripheral side in the radial direction. The outer diameter of the end face pressing part 51D is formed equal to those of the magnets 21.

The thus-configured rotor unit 1D according to the fourth embodiment makes it possible to make the end face pressing part 51D of a metal by casting the end face pressing part 51D to the press-fit holding part 52A (by casting). It is therefore possible to make the metal part of the press-fit holding part 52A exert the collar characteristic (the function of being press-fitted to the shaft part 30a). Furthermore, even if an impact in the axial direction G is inputted into the rotor core 12 and a force in the axial direction G works on the magnets 21, it is possible to prevent the magnets 21 from coming (dropping) out of the rotor core 12.

Moreover, the fourth embodiment can inhibit detachment of the magnets 21 even if the magnets 21 are formed attached to the rotor core 12 in a way that makes the magnets 21 movable in the axial direction G.

### Fifth Embodiment

FIG. 8 is a cross-sectional view showing a rotor unit according to a fifth embodiment.

As illustrated in FIG. 8, the rotor unit 1E according to the fifth embodiment includes end plates 40B, 50E instead of the end plates 40A, 50D according to the fourth embodiment.

The end plate 40B is formed in a disk shape, and is made of a nonmagnetic metal material, for example SUS304, aluminum, copper or the like, as well as is arranged coaxially with the rotating shaft 30. A claw part 41 in engagement with the outer peripheral surfaces of the magnets 21 is formed in the outer peripheral edge portion of the end plate 40B. The claw part 41 is formed fully in a circle in the circumferential direction, or so partially as to engage with all the magnets 21.

Like in the end plate 40B, in the end plate 50E, a claw part 51g in engagement with the outer peripheral surfaces of the magnets 21 is formed in the outer peripheral edge portion of an end face pressing part 51E. The claw part 51g is formed fully in a circle in the circumferential direction, or so partially as to engage with all the magnets 21.

The thus-configured rotor unit 1E according to the fifth embodiment can obtain the same effects as that according to the fourth embodiment can. The claws 41, 51g make it possible to securely prevent the detachment of the magnets 21.

Furthermore, because of the claws 41, 51g, the fifth embodiment makes a step of fixing the magnets 21 to the rotor core 12 no longer necessary.

Although the fifth embodiment has been discussed by citing the shape in which the claws 41, 51g project outward from the magnets 21 in the radial direction, a shape may be employed in which the outer peripheral surfaces of the end face pressing parts 51A to 51E are flush with the outer peripheral surfaces of the magnets 21.

The present invention is not limited to the foregoing embodiments, and includes various modifications. For example, the embodiments have been discussed by citing the configuration in which: the diameter-enlarged part 30b is formed in the rotating shaft 30; and the end plates 40A, 40B are butted with the face 30c of the diameter-enlarged part 30b. However, the present invention is not limited to this configuration. A configuration may be employed in which the rotor core 10 is held by press-fitting the end plates 50A to 50E to the rotor core 10 from the two sides of the rotor core 10.

Furthermore, although the embodiments have been discussed by citing the shape in which the press-fit holding parts 52A to 52C are set back from the surfaces 51c of the end face pressing parts 51A to 51E which face the rotor cores 10, 12, a shape may be employed in which the surfaces 51d of the press-fit holding parts 52A to 52C which face the rotor cores 10, 12 are flush with the surface 51c of the end face pressing parts 51A to 51E which face the rotor cores 10, 12.

Moreover, the embodiments have been discussed by citing the structure in which the end face pressing parts 51A to 51E are fitted to the press-fit holding parts 52A to 52C, a structure may be employed in which the end face pressing parts 51A to 51E are not fitted to the press-fit holding parts 52A to 52C.

Although the embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS

1A, 1B, 1C, 1D, 1E: Rotor unit; 10, 12: Rotor core; 20, 21: magnet; 30: Rotating shaft; 30a: Shaft part; 30b: Diameter-enlarged part; 30c: Face; 40, 40A, 40B: End plate; 50A, 50B, 50C, 50D, 50E: End plate; 51A, 51B, 51C, 51D, 51E: End face pressing part; 52A, 52B, 52C: Press-fit holding part

What is claimed is:

1. A rotor unit comprising:
a rotor core;
a magnet provided in the rotor core and extending in an axial direction;
a rotating shaft inserted through a center of the rotor core; and
an end plate provided on an end face in the axial direction of the rotor core, wherein
the end plate includes
an end face pressing part arranged on an outer peripheral side of the rotor core and facing the magnet, and
a press-fit holding part arranged on an inner peripheral side of the rotor core and press-fitted to the rotating shaft, and
the end face pressing part and the press-fit holding part are combined together by casting.

2. The rotor unit according to claim 1, wherein
in the end plate, the end face pressing part and the press-fit holding part are combined together by fitting the end face pressing part to the press-fit holding part.

3. The rotor unit according to claim 1, wherein
the end face pressing part is made of metal containing aluminum, and the press-fit holding part is made of metal containing iron.

4. The rotor unit according to claim 1, wherein
the magnet is inserted in the rotor core in a way that makes the magnet movable in the axial direction.

5. The rotor unit according to claim 1, wherein
a face of the end face pressing part which faces the rotor core is flush with the press-fit holding part, or the press-fit holding part is set back from the end face pressing part.

6. The rotor unit according to claim 2, wherein
the end face pressing part is made of metal containing aluminum, and the press-fit holding part is made of metal containing iron.

7. The rotor unit according to claim 2, wherein
the magnet is inserted in the rotor core in a way that makes the magnet movable in the axial direction.

8. The rotor unit according to claim 3, wherein
the magnet is inserted in the rotor core in a way that makes the magnet movable in the axial direction.

9. The rotor unit according to claim 2, wherein
a face of the end face pressing part which faces the rotor core is flush with the press-fit holding part, or the press-fit holding part is set back from the end face pressing part.

10. The rotor unit according to claim 3, wherein
a face of the end face pressing part which faces the rotor core is flush with the press-fit holding part, or the press-fit holding part is set back from the end face pressing part.

11. The rotor unit according to claim 4, wherein
a face of the end face pressing part which faces the rotor core is flush with the press-fit holding part, or the press-fit holding part is set back from the end face pressing part.
